(19) United States
(12) Patent Application Publication
(10) Pub. No.: US 2012/0077157 A1
(43) Pub. Date: Mar. 29, 2012

(54) METHODS AND DEVICES FOR EDUTAINMENT SPECIFICALLY DESIGNED TO ENHANCE MATH SCIENCE AND TECHNOLOGY LITERACY FOR GIRLS THROUGH GENDER-SPECIFIC DESIGN, SUBJECT INTEGRATION AND MULTIPLE LEARNING MODALITIES

(76) Inventors: Emily K. Clarke, Leesburg, VA (US); Kathryn A. Clarke, Leesburg, VA (US)

(21) Appl. No.: 13/248,902

(22) Filed: Sep. 29, 2011

Related U.S. Application Data
(60) Provisional application No. 61/387,854, filed on Sep. 29, 2010.

(51) Int. Cl. G09B 23/02

(52) U.S. Cl. 434/188

(57) ABSTRACT

Novel edutainment methods and devices designed by women for girls, based on learning and motivational psychology research, are provided. Further, the methods and devices provide a learning environment for math education that is integrated, multi-modal, and crafted to enhance the motivation, confidence, and math skills of girls in primary and secondary grades.

### BACKGROUND

Research conducted by the Girls, Math & Science Partnership concludes that despite recent advances, boys still outperform girls in primary science, math, and technology education. Girls are under-enrolled in Advanced Placement Computer Science and Physics classes, and eighth grade boys typically exhibit higher performance than girls in fractions, number sense, and the core sciences, and demonstrate higher scientific confidence. Girls as a whole are still behind in math and science enrollment and scores. Girls lack confidence in their ability to perform math and feel unmotivated to continue their education in math and science past the level required to graduate. Consequently, girls are under-represented in college-level math, science, and technology classes. Girls also find math impersonal, uncreative, and based in memorization alone.

Math education software (also called “edutainment” software when structured as a game rather than strictly as a tutorial) is designed to encourage students to improve their math skills by making learning a fun and motivational activity. Previous and current edutainment games have focused either on math manipulatives (virtual objects or activities designed to allow the student to learn and practice math skills) or on math problem solving (adventure games, for example). However, these offerings have not focused specifically on the factors that encourage and motivate girls to learn math, and in fact, some games contain elements that specifically discourage girls and undermine their confidence and motivation. In addition, games currently and previously on the market do not incorporate science and technology education in a way that is integral to the application of math skills, nor do they incorporate spatial skills building, which is an area of specific concern in math education for girls. Finally, the current state of the art supports math learning in only one modality; i.e., by teaching math directly and in isolation from other subjects, rather than by incorporating math into a context that supports multiple ways of learning and applying skills.

### BRIEF DESCRIPTION OF THE DRAWINGS

FIG. 1 depicts functional elements of exemplary embodiments of the invention designed to improve girls' motivation and confidence with math.

FIG. 2 depicts functional subcomponents and features of an exemplary system architecture according to one embodiment of the invention.

FIG. 3 depicts a flow chart of game play that a player or user may encounter in an exemplary game according to one embodiment of the invention.

FIG. 4 depicts multiple learning pathways created by using multi-modal learning according to embodiments of the invention.

FIG. 5 depicts several functional modalities used to enhance depth of learning incorporated within embodiments of the present invention.

FIG. 6 depicts devices incorporating features and functions according to one or more embodiments of the invention.

### SUMMARY

This application discloses embodiments directed to edutainment methods and devices specifically designed by women for girls, based on learning and motivational psychology research, to provide a learning environment for math education that is integrated, multi-modal, and crafted to enhance the motivation, confidence, and math skills of girls in primary and secondary grades.

To address the shortcomings of existing math educational tools that are not well suited for girls, novel methods and devices (referred to hereafter as “embodiments of the invention”) provide a player or user with the opportunity to be the heroine of her own journey, build unique and personal mentoring relationships with female role models, and in the process, envision herself as a new math, science, and technology archetype. Embodiments also provide the elements recommended by learning and motivational psychology research as necessary for girls to feel motivated, build confidence, overcome negative stereotypes, and associate math proficiency with helping people, building relationships, and solving humanitarian as well as scientific and technological problems.

Further embodiments incorporate multiple learning modes in order to enhance and deepen the skills learned beyond that afforded by mere repetition of math exercises and manipulations. Research and teaching practice have demonstrated that student learning is increased by repeating concepts in related and perhaps even unfamiliar ways so that multiple neural connections and relationships are formed in the brain. Learning through multiple connections can create multiple ways in which information learned can be retrieved, associated, and applied, thereby increasing the depth of knowledge and the range of problem domains in which that knowledge can be used.

Yet further, other embodiments integrate the mastery of mathematical skills with science, technology, engineering, and other subject areas, which both creates multiple associations for new knowledge and provides contexts for math proficiency that are more interesting, motivating, and meaningful for girls. By providing a broader scope of skills and scenarios in which math is learned and used, the embodiments enable and empowers girls to have greater confidence in their abilities, gain a deeper understanding of math and science, and continue their educations in math, science, engineering, and technology.

Still further embodiments include games and sub-games for personal computers and mobile devices, to name just a few examples.

Specific embodiments include a method and related device for enhancing math, science, and technology literacy through the completion of a core group of initial mini-edutainment games, and one or more short, animated cut-scenes, wherein a sense of action, time lapse, and plot advancement is conveyed through the animated cut-scenes and character interactions.

The one or more initial mini-edutainment games may be: (a) for different grade levels; (b) stand alone games; (c) stand alone games that build on skills learned in previous games. In addition, the one or more mini-edutainment games may comprise: (1) characters that persist through multiple games, thereby providing a consistent support mechanism and maintaining a relationship context across the mini-edutainment games based on the persistence of such characters; and (2) a similar math and science structure that encourages ease with technology based on the similar structure.

Alternative embodiments may include the ability to communicate with one or more role model mentors, where the role model mentors may be female role models. A user may communicate with the role model during a mini-edutainment game. Further embodiments may include the control of both the role model mentors and optionally created avatar(s), where the avatars may be customized based on features selected from the group consisting of at least skin tone, clothing item, color, hairstyle, facial feature, and name. Each avatar may be moved around within a mini-edutainment game, and/or may be caused to interact with other characters and activities within a mini-edutainment game. The avatar (or avatars) may comprise non-stereotypical female avatars and may be associated with a name, background story, and/or personality.

Each of the features and/or functions described above may be implemented by a device that comprises one or more memories, wherein the one or more memories comprise stored instructions for executing the features and functions described above. The device may comprise, for example, a mobile device or desktop computer.

### Detailed Description, Including Exemplary Embodiments

Multiple academic studies suggest design points that encourage girls in math education. The Girls, Math & Science Partnership suggests making math more personal, helping girls appreciate math and science for its virtues instead of its utility in school; giving girls the feeling of control over their abilities in science and math; creating a “New Science Girl” archetype to shatter the “math is for geeks [or nerds or boys]” stereotype; reminding girls that math and science can have rewarding, inspirational, elegant, and humanitarian aspects; and encouraging girls to explore what they can do with math and science. The Institute of Educational Sciences suggests teaching girls that their cognitive abilities are not fixed; giving girls specific feedback; providing strong female role models; linking math, science, and technology to unusual (non-stereotypical) and interesting careers and activities; creating opportunities for research; and providing spatial skills training. The Commission on Technology, Gender, and Teacher Education suggests implementing strategy, personal interactions, diverse and interesting characters, narrative plots, non-stereotyped creativity, and appropriate challenge into edutainment games.

Building on this research, teaching practice, and additional research performed by the inventors, embodiments of the invention incorporate the following concepts that make the inventive methods and devices uniquely suited to enhance motivation, confidence, and skill building for girls who are learning and practicing math:
Engaging, evolving, narrative plot
Progressive strategy that spans multiple games and builds on learned skills
Progress tracking
Prescriptive feedback, suggestions, and the ability to study
Social relationship context with a diverse cast of female characters
Presentation of female role models
Helping context where math is used to help others
Encouraging comfort and ease with technology through the use of a helpful animated character the player can befriend
Stereotype free customization of a player avatar
Spatial skills training

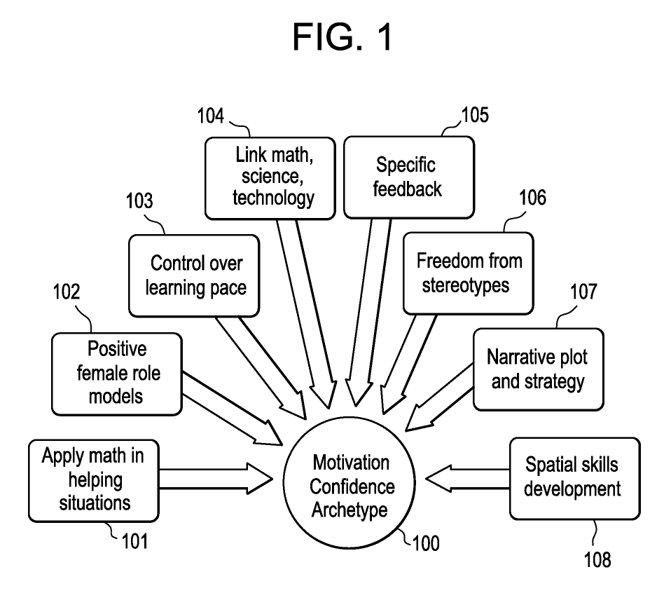

FIG. 1 depicts functional elements 101-108 of exemplary embodiments of the invention designed to improve girls' motivation and confidence with math by enhancing the motivation and confidence of girls, and empowering girl players/users to envision themselves as the new archetype math and science girl.

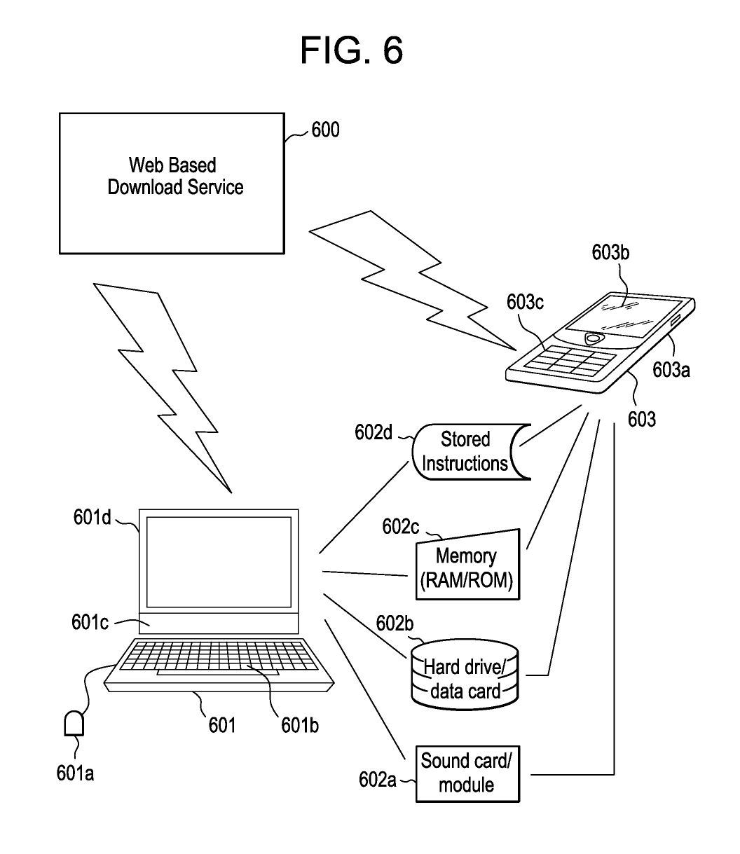

A common problem with edutainment games is keeping users and players (collectively referred to as “users” herein) interested and motivating them to play a game through to its ending. A narrative, engaging, evolving plot in which the user's progress causes the plot to advance has been implemented to counter this problem. The more mini-games the user completes, the more the plot is revealed to the user, thus motivating users to complete all the activities. For example, in one embodiment of the invention a user may complete a core group of initial mini-games in any order. The user may then unlock several others to complete, each followed by a short, animated cut-scene that leads to the conclusion of the game. A sense of action, time lapse, and plot advancement will be conveyed through the animated cut-scenes and character interactions. The user may also track her score throughout the game at a specially-designed information screen that is, for example, made a part of an exemplary device (see FIG. 6) in order to gauge her progress. Seeing a tangible record of her progress will help the user feel as if she is making strides not only in the game but also in her math abilities.

The strategy and narrative flow may continue through multiple games designed for different grade levels. Each game may stand alone and may also build on skills learned in previous games. Helping characters also persist through multiple games in the series, providing a consistent support mechanism as well as maintaining a key part of the relationship context across multiple games. Each game may also be structured similarly so that the user may concentrate on the math skills and the science mystery to be solved rather than having to learn completely different game structures and flows each time. This consistency encourages ease with technology as a meta-theme across games.

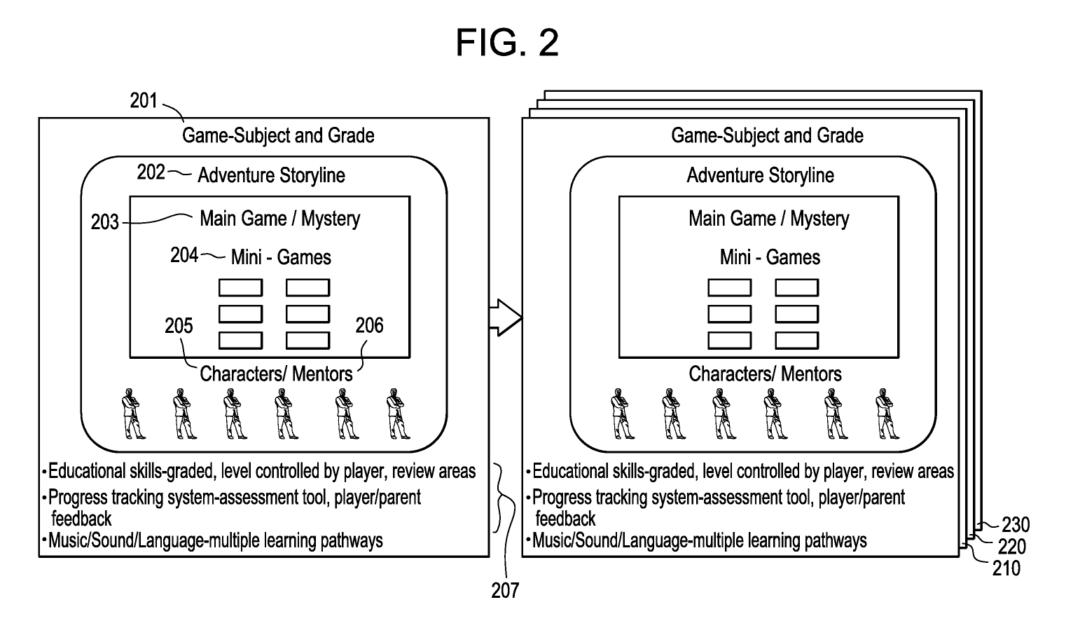

FIG. 2 depicts functional subcomponents and features 201-207 and 210, 220 and 230 of an exemplary system architecture according to one embodiment of the invention. The subcomponents and features illustrate relationships between different games in a series and indicate an exemplary flow from game to game as well as a consistent structure and look and feel. The high level game architecture in described as follows. Each game 201 may be denoted by grade and subject, e.g, fourth grade math. Each game 201 may entail an adventure storyline 202 that may consist of a science endeavor (e.g., space exploration) that provides the general impetus for the game, introduces girls to science concepts, and facilitates the flow of the game. Each game 201 may include one or more mini-games 204. A mini-game 204 may consist of a self-contained area (such as a room or chamber) where the user has the opportunity to practice a skill or set of skills in order to solve a puzzle or problem so she can move on in the game. For example, a user may have to master a series of multiplication facts in order to unlock a cipher lock that provides a clue necessary to progressing in the game. Completing all of the mini-games 204 gives the user the ability to complete the endeavor in the adventure storyline. Each game 201 may also consist of multiple characters 205 and female role model mentors 206 that assist the user in completing mini-games and following the adventure storyline. These characters 205 and mentors 206 may also provide information related to the subject matter of the game. Some of the characters 205 may also provide the user with a sense of efficacy and provide motivation to complete the adventure storyline in a context of helping others. For example, one mini-game 204 may provide the user with the opportunity to save a character (e.g., a puppy), who then becomes a companion for the remainder of the game. Each game 201 may contain content 207 that is grade appropriate and may be provided at a difficulty level that is controlled by the user. Each game 201 may also contain review areas 207 where the user can practice and review skills, including the ability to access a friendly computer character who provides help and also increases the player's comfort with using technology to solve problems. Each game 201 may also contain a progress tracking system 207 that provides feedback and assessment information to the user and her parents. This feedback may provide motivation to the user by demonstrating her game progress and skills growth. In addition, parents may be able to observe their child's skills level and progress. Each game 201 may include the use of music, sounds, and foreign languages to form multiple learning pathways for math facts. This high level architecture may persist through each game in a series of games 210, 220, 230 that allow the user to interact with common characters and experience similar game play and features.

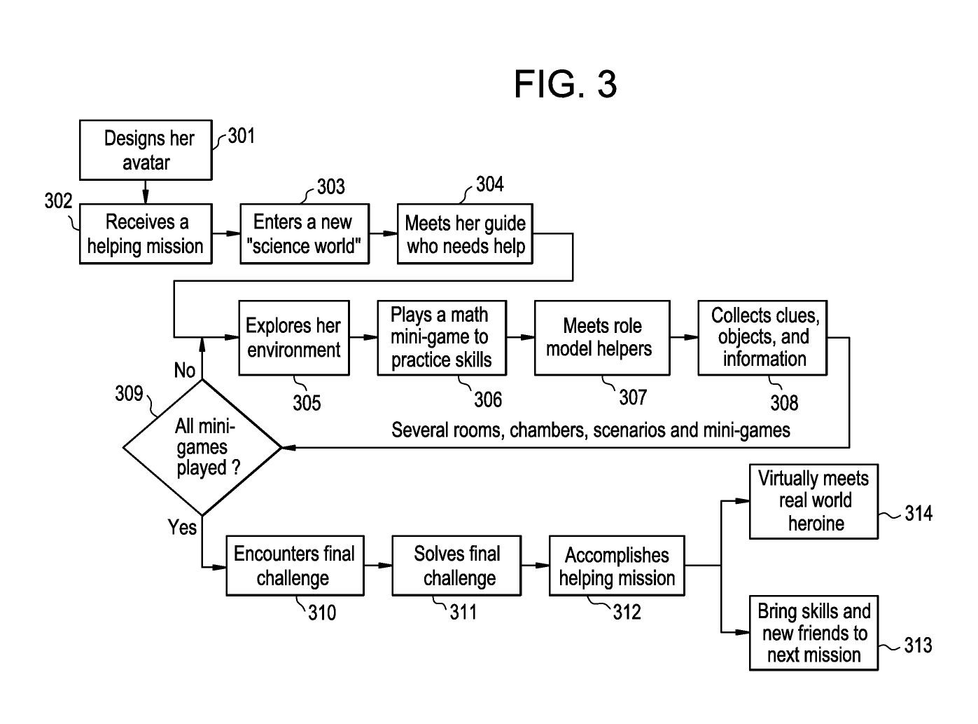

FIG. 3 depicts a flow chart of game play that a user may encounter in an exemplary game according to one embodiment of the invention. The flow chart includes an exemplary narrative plot flow 301-314 within a game and shows how the user may be led through a game to complete her helping mission by playing mini-games and practicing her math skills with the help of role model mentors. In the exemplary game flow, the user first designs her avatar 301, then receives a helping mission 302, enters a new “science world” 303, and meets her guide who needs help 304. She then explores her environment 305, plays several math mini-games located in several rooms or chambers and incorporating several scenarios 306, meets role model helpers 307, and collects clues 308, objects and information. If all mini-games have not been played, she continues playing mini-games 309. Once all mini-games have been played, the user encounters a final challenge 310, solves the final challenge 311, accomplishes the helping mission 312, and virtually meets a real world heroine 314. She then has the opportunity to bring her skills and new character friends to the next mission in the next game 313.

Another common problem in edutainment games is a lack of prescriptive feedback. In alternative embodiments of the invention, when the user answers a problem incorrectly, she will be pointed towards study resources that give hints and review skills to better strengthen her abilities. These study resources are designed to be more helpful than the typical “Try again” often seen in edutainment games. Although these resources will help users review, they are not designed to teach the subjects in the game; instead they are there to help users learn how to correct their mistakes without time pressure and the frustration of having to call upon outside resources in order to finish the game.

In an additional embodiment of the invention a user may be asked to create an avatar as the very first stage of the game. Although the cast of game characters is diverse, it is unlikely that the user will find a character exactly like her. In a further embodiment of the invention, a user may create and control avatars. A base character may be initially created and given to the user which may then be customized with different skin tones, items of clothing in various colors, different hairstyles, facial features, and her own name. The avatar represents the user during game play. The user may be able to move her avatar around the game stage and interact with other characters and activities.

The characters that may be created are important for overcoming stereotypes that undermine girls' confidence and self-perceptions of math proficiency. In currently available edutainment games, most characters are white males, leaving female and non-white users without characters they can relate to. In contrast, in accordance with embodiments of the invention games incorporate entirely female characters having a number of different ethnicities.

The characters may be presented free of typical stereotypes such as those in “pink” games, where the context is associated with activities such as child care, environments such as fairy tales, and play-along characters such as name brand dolls. Instead, the characters created by embodiments of the invention are strong female role models of diverse backgrounds who relate to the user character as a peer and engage the user character in collaborative missions and activities, while offering assistance and mentorship in a field of science, technology, or engineering. In addition, the game play environments provided by embodiments of the invention are associated with science endeavors such as space exploration, archaeology, etc. To provide the realistic social interaction that girls prefer, game characters may be provided with names, background stories, and distinct personalities, and may talk extensively to the user during game play. The characters may also be created and controlled by the same or similar components of an exemplary device that creates and controls the avatars.

In yet an additional embodiment of the invention, an additional character may be created in the form of a friendly, animated computer facsimile that may serve as a source of online help with game play as well as the source of hints while the user is solving mathematical puzzles and problems. Most importantly, however, the computer character may be designed to create a positive association for girls with technology. The computer character interacts with the user in a helpful and friendly way, helping and encouraging the user through math exercises. This friendly interaction continues not only in a game but across multiple games, reinforcing that technology is the user's friend and an ever-present tool and aid in the worlds of math, science, and engineering.

Still further embodiments of the invention may include the creation of mini-games within each game that present mathematical exercises to reinforce grade level appropriate concepts and provide the user with the opportunity to practice math skills and problem solving. These mini-games may be available throughout the game so that the user can repeat them as desired to practice and gain confidence in her skills. The mini-games may also be leveled so that they can be presented at several different difficulty levels, allowing more advanced users to challenge themselves and their skills, but also allowing less advanced users to learn skills more thoroughly at a more fundamental level before proceeding to a more challenging level. These concepts, repetition and self-selected leveling, combine to give girls control over their learning pace, another key element in creating an optimal motivational environment for learning math.

In additional embodiments of the invention, a specialized category of mini-games may be provided to train girls in spatial skills Boys typically outperform girls in spatial skills tests, and strong spatial skills can be a major advantage in studying science, technology, engineering, and math. In accordance with one embodiment of the invention, a spatial skills game may involve a user matching a folded cube (3-D shape) with one of several unfolded cubes (2-D shape). Another embodiment may involve using shape and color cues to assemble the parts of a robot. The development of spatial skills addresses an area of concern in girls' math skills while also providing a fundamental building block for engineering education, where the identification and manipulation of spatial objects is core to the application of math and science skills to solving real-world problems. Solving such problems in a creative environment associated with a humanitarian (or “helping”) context addresses a specific complaint of female game users regarding the lack of creativity in edutainment games. It also helps to overcome the stereotypical presumption that games for girls should involve activities such as dress designing or paint-by-numbers, and instead encourages the new math and science girl archetype.

To provide additional creative learning options for female users, embodiments of the invention may further incorporate music and language with math education. Such music and/or language capabilities may be implemented using one or more audio components included in an exemplary device in conjunction with stored instructions (see FIG. 6). This embodiment of the invention also serves to repeat and re-state math concepts in ways that involve different brain centers in learning the same materials. For example, learning math multiplication facts may be presented as a series of multiplication problems that must be solved. They may also be presented, however, in a foreign language, following the presentation of digits in the same language, so that two skills are now involved in learning the same math facts—learning the facts themselves, and learning a foreign language representation of the same facts. In alternative embodiments, the repetition of the material through two presentation modes and learning centers creates multiple learning pathways, yielding greater recall of the basic material—the math facts. Not incidentally, this form of learning presentation also begins the teaching of one or more (at the user's discretion) foreign languages, because the same principle would apply; i.e., the language facts are also being presented in multiple ways, creating enhanced learning of these facts as well.

Presenting math facts in other modes incorporated in embodiments of the invention can also help users overcome anxieties they may feel about learning or practicing math. By learning math with a language, for example, the user is not focused on her feelings about math itself but on learning to communicate and manipulate numbers in the context of learning a language. In the inventors' experience, this has shown to be particularly helpful in overcoming “panic” feelings about math that have resulted, for instance, from having to perform timed math exercises.

Associating the same set of concepts with multiple pathways is accomplished through additional embodiments of the invention not only through the use of language but also through the use of music. Songs and tunes may be used like languages to create multiple learning pathways for math facts, not just as mnemonic devices but as ways to reinforce math facts by presenting a creative object that the user may associate with a math fact or set of facts.

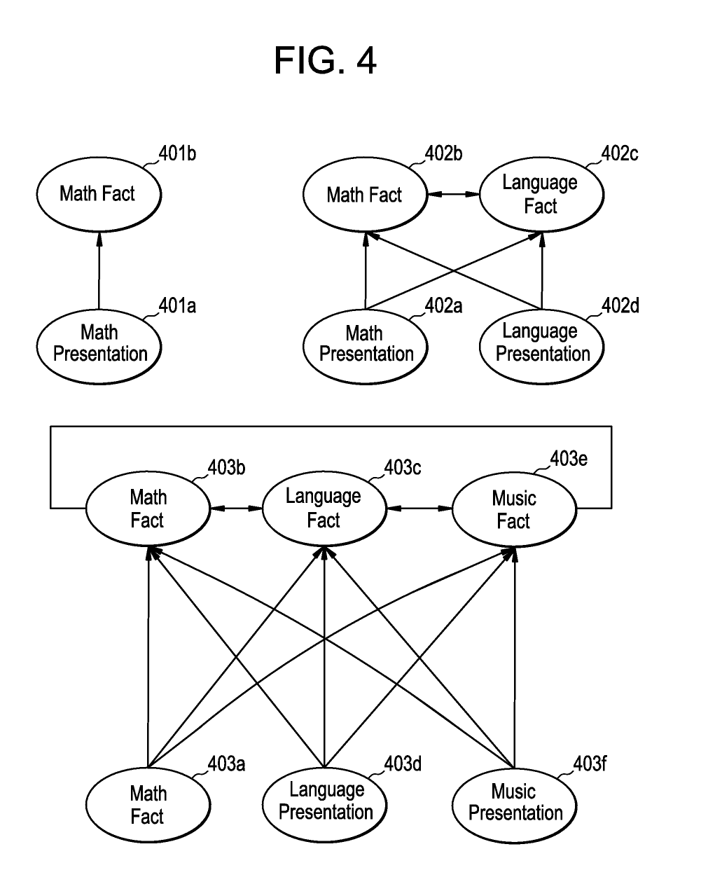

FIG. 4 depicts multiple learning pathways 401a through 403f that may be created by using multi-modal learning according to embodiments of the invention. It should be noted that the exemplary pathways 401a through 403f maybe used as the foundation for creating exponentially more pathways as more modalities are used.

The concept of multiple modalities may be used not only with creative media such as languages and music, but also with other concepts presented earlier that are also specifically beneficial to girls learning math. For example, associating math facts in a helping context, where learning math is not an end unto itself but rather a technique used to serve a higher purpose, makes the math facts more fun to learn and motivates the user to learn in order to work toward the higher level goal. Similarly, learning spatial skills to build a character that will then assist the user in the larger purpose is motivating in addition to helping create new pathways and associations for math literacy in the larger sense.

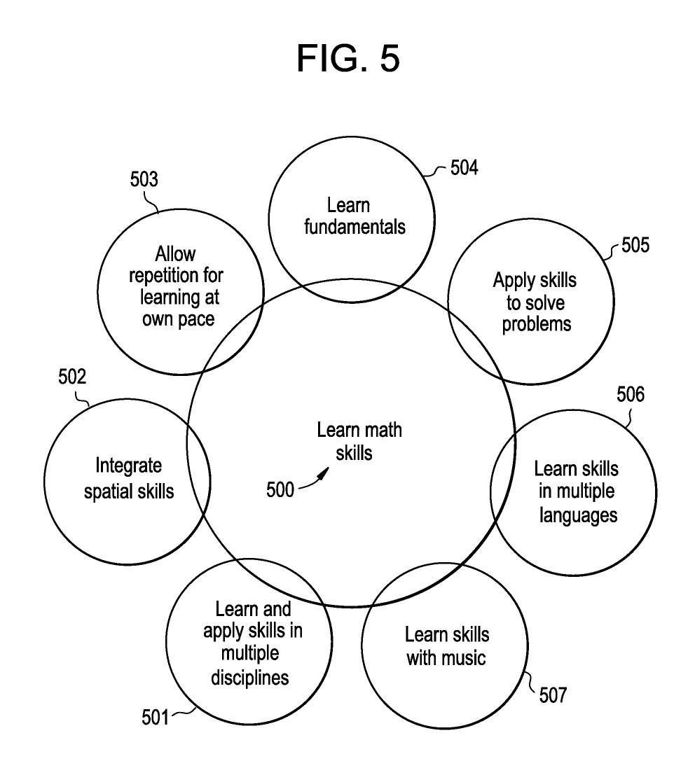

FIG. 5 depicts several functional modalities 500-507 used to enhance depth of learning incorporated within embodiments of the present invention. Applying math facts across multiple problem domains through the use of language, music, and other modalities extends the range of usefulness of math for the user. To truly develop math literacy and proficiency, one must be able to apply math skills to multiple problem areas and disciplines. To that end embodiments of the invention may provide the user with the ability to develop math literacy and proficiency by the use of multiple learning modalities 500-507 which may include learning math fundamentals 504, applying skills to solve problems 505, learning skills in multiple languages 506, learning skills with music 507, learning and applying skills in multiple disciplines 501, integrating spatial skills 502, and allowing repetition for learning at the user's own pace 503.

FIG. 6 depicts exemplary devices 601, 603 incorporating one or more of the features and functions of the present invention described above. The devices shown are, for example, a desktop, laptop or tablet computer 601 and mobile phone, PDA or smartphone 603. Each of the exemplary devices 601, 603 may comprise of one or more components. For example device 601 may comprise components 601a-d and 602a-d while device 603 may comprise components 603a-c and 602a-d. As shown, each device may comprise one or more processors and/or memories 601c, 602b, 602c, 603a for storing and executing instructions downloaded, for example, or otherwise accessed, from a web site or the like to complete the features and functions of one or more of the many embodiments of the invention described above. The instructions 602d (represented separately, but with the understanding that they are stored in one or more memories) may be stored in one or more places, such as internal device RAM or ROM type of memories 602c or on external hard drives 602b to be executed when the user desires, in conjunction with the user's use of one or more input/output (I/O) components such as a keyboard 601b, 603c, mouse 601a, display 601d, touch screen 603b, or other audio/video I/O 602a, to name just a few examples.

The devices 601, 603 may be wireless or wired devices. As mentioned above, when executed, the instructions 602d provide one or more of the features and their related functionality described above, including the creation, control and provisioning of games, mini-games, avatars, characters, spatial skills games, music/language features, and linking features, to name just a few examples. It should be noted that the features, functions, instructions, devices, and methods described herein are not abstract ideas, fundamental scientific principles, or mental processes.

Last, but not least, embodiments of the invention may provide the capability of linking a user and/or her associated device(s) to interesting real-world math, science, engineering, and technology activities and opportunities. For example, users of a space exploration game will have the opportunity to link via the Internet to resources on space exploration and possibly even to biographies, stories, and interviews with female astronauts. These real-world connections provide additional female role models for the user and reinforce the usefulness of math in human, social, and relationship oriented contexts.

It should be understood that the description above provides only some of the many embodiments for implementing the concepts of the present invention. Though it may be impractical to set forth each and every possible alternative embodiment, or variations of the embodiments set forth above, such embodiments are nonetheless considered within the scope of the present invention. Such scope is better represented by the claims that follow.

We claim:

1. A method for enhancing math, science, and technology literacy comprising:
completing a core group of initial mini-edutainment games,
and one or more short, animated cut-scenes,
wherein a sense of action, time lapse, and plot advancement is conveyed through the animated cut-scenes and character interactions.

2. The method as in claim 1 wherein one or more of the initial mini-edutainment games are for different grade levels.

3. The method as in claim 1 wherein one or more of the initial mini-edutainment games are stand alone games.

4. The method as in claim 1 wherein one or more of the initial mini-edutainment games are stand alone games that build on skills learned in previous games.

5. The method as in claim 1 wherein one or more of the initial mini-edutainment games comprise characters that persist through multiple games, and the method further provides a consistent support mechanism and maintains a relationship context across the mini-edutainment games based on the persistence of such characters.

6. The method as in claim 1 wherein each of the mini-edutainment games comprises a similar math and science structure, and the method further encourages ease with technology based on the similar structure.

7. The method as in claim 1 further comprising communicating with one or more role model mentors.

8. The method as in claim 7 wherein the role model mentors are female role models.

9. The method as in claim 1 further comprising pointing a user to study resources that include hints and review skills when the user answers a problem within a mini-edutainment game incorrectly.

10. The method as in claim 1 further comprising creating and controlling an avatar.

11. The method as in claim 10 further comprising customizing the avatar based on features selected from the group consisting of at least skin tone, clothing item, color, hairstyle, facial feature, and name.

12. The method as in claim 10 further comprising moving the avatar around within a mini-edutainment game.

13. The method as in claim 10 further comprising causing the avatar to interact with other characters and activities within a mini-edutainment game.

14. The method as in claim 1 further comprising creating and controlling one or more role model avatars.

15. The method as in claim 14 wherein the one or more role model avatars comprise non-stereotypical female avatars.

16. The method as in claim 14 further comprising engaging a user and one or more of the female avatars in collaborative missions and activities, wherein such engagement provides assistance and mentorship in a field of mathematics, science, technology, or engineering.

17. The method as in claim 14 wherein each of the avatars is associated with a name, background story, and personality.

18. The method as in claim 14 further comprising allowing the one or more role model avatars to communicate with a user during a mini-edutainment game.

19. The method as in claim 1 further comprising creating an animated character that provides help to a user involved in a mini-edutainment game.

20. The method as in claim 19 further comprising creating the animated character, wherein the character creates a positive association for the user and technology.

21. The method as in claim 19 further comprising interacting the animated character with the user, wherein the interaction assists and encourages the user in mathematical, edutainment mini-games.

22. The method as in claim 1 wherein one of the mini-edutainment games comprises a spatial skills game, wherein the game comprises identification and manipulation of spatial objects.

23. The method as in claim 1 further comprising controlling one or more audio components that provide musical and language audio associated with a mathematical mini-edutainment game.

24. The method as in claim 23 wherein the language is a foreign language.

25. The method as in claim 1 further comprising linking the user to female role models in math science and engineering.

26. The method as in claim 1 further comprising tracking a mini-edutainment game related score.

27. The method as in claim 1, further comprising providing a mobile device to complete the method.

28. The method as in claim 1, further comprising providing a desktop computer to complete the method.

29. A device comprising one or more memories, wherein the one or more memories comprise stored instructions for:
completing a core group of initial mini-edutainment games,
and one or more short, animated cut-scenes,
wherein a sense of action, time lapse, and plot advancement is conveyed through the animated cut-scenes and character interactions.

30. The device as in claim 29 wherein one or more of the initial mini-edutainment games are for different grade levels.

31. The device as in claim 29 wherein one or more of the initial mini-edutainment games are stand alone games.

32. The device as in claim 29 wherein one or more of the initial mini-edutainment games are stand alone games that build on skills learned in previous games.

33. The device as in claim 29 wherein one or more of the initial mini-edutainment games comprise characters that persist through multiple games, and the one or more memories further comprises instructions for providing a consistent support mechanism and maintaining a relationship context across the mini-edutainment games based on the persistence of such characters.

34. The device as in claim 29 wherein each of the mini-edutainment games comprises a similar math and science structure, and the one or more memories further comprises instructions for encouraging ease with technology based on the similar structure.

35. The device as in claim 29 wherein the one or more memories further comprises instructions for communicating with one or more role model mentors.

36. The device as in claim 35 wherein the role model mentors are female role models.

37. The device as in claim 29 wherein the one or more memories further comprises instructions for pointing a user to study resources that include hints and review skills when the user answers a problem within a mini-edutainment game incorrectly.

38. The device as in claim 29 wherein the one or more memories further comprises instructions for creating and controlling an avatar.

39. The device as in claim 38 wherein the one or more memories further comprises instructions for customizing the avatar based on features selected from the group consisting of at least skin tone, clothing item, color, hairstyle, facial feature, and name.

40. The device as in claim 38 wherein the one or more memories further comprises instructions for moving the avatar around within a mini-edutainment game.

41. The device as in claim 38 wherein the one or more memories further comprises instructions for causing the avatar to interact with other characters and activities within a mini-edutainment game.

42. The device as in claim 29 wherein the one or more memories further comprises instructions for creating and controlling one or more role model avatars.

43. The device as in claim 42 wherein the one or more role model avatars comprise non-stereotypical female avatars.

44. The device as in claim 42 wherein the one or more memories further comprises instructions for engaging a user and one or more of the female avatars in collaborative missions and activities, wherein such engagement provides assistance and mentorship in a field of mathematics, science, technology, or engineering.

45. The device as in claim 42 wherein each of the avatars is associated with a name, background story, and personality.

46. The device as in claim 42 wherein the one or more memories further comprises instructions for allowing the one or more role model avatars to communicate with a user during a mini-edutainment game.

47. The device as in claim 29 wherein the one or more memories further comprises instructions for creating an animated character that provides help to a user involved in a mini-edutainment game.

48. The device as in claim 47 wherein the one or more memories further comprises instructions for creating the animated character, wherein the character creates a positive association for the user and technology.

49. The device as in claim 47 wherein the one or more memories further comprises instructions for interacting the animated character with the user, wherein the interaction assists and encourages the user in mathematical, edutainment mini-games.

50. The device as in claim 29 wherein one of the mini-edutainment games comprises a spatial skills game, wherein the game comprises identification and manipulation of spatial objects.

51. The device as in claim 29 wherein the one or more memories further comprises instructions for controlling one or more audio components that provide musical and language audio associated with a mathematical mini-edutainment game.

52. The device as in claim 51 wherein the language is a foreign language.

53. The device as in claim 29 wherein the one or more memories further comprises instructions for linking the user to female role models in math science and engineering.

54. The device as in claim 29 wherein the one or more memories further comprises instructions for tracking a mini-edutainment game related score.

55. The device as in claim 29 wherein the device comprises a mobile device.

56. The device as in claim 29 wherein the device comprises a desktop computer.
